(19) United States
(12) Patent Application Publication
(10) Pub. No.: US 2026/0360269 A1
(43) Pub. Date: Nov. 12, 2026

(54) GENERATIVE AI EDUCATIONAL SYSTEM AND OPERATIONAL METHOD

(71) Applicant: HONG-JUN CHEN, Taipei City (TW)

(72) Inventor: HONG-JUN CHEN, Taipei City (TW)

(21) Appl. No.: 19/199,424

(22) Filed: May 6, 2025

(51) Int. Cl. G09B 7/00; G06N 20/00

(52) U.S. Cl. CPC G09B 7/00; G06N 20/00

(57) ABSTRACT

An AI-generated intelligent educational teaching system includes a backend server, a user-end device, and an administrator-end device. The backend server stores an AI teacher instructional large model, a teaching material database, a 3D database, an AI test question large model, a student learning record database, a learning trajectory analytics module, and a student lesson preparation database. The user-end device is an electronic display device used to connect to the backend server and display relevant data stored therein. The administrator-end device is also an electronic display device used to connect to the backend server to access and display the student learning record database and the learning trajectory analytics module. This system and its operational method aim to enhance students' learning effectiveness and reduce the educational gap between urban and rural areas.

### BACKGROUND OF THE INVENTION

### (a) Technical Field of the Invention

The present invention generally relates to education and teaching, and more particularly to an educational system and its operational method based on generative artificial intelligence (AI).

### (b) Description of the Prior Art

Currently, most school courses—such as regular classes, make-up classes, continuing education programs, and skills training courses—are primarily conducted through in-person teaching. Alternatively, some courses are recorded during in-person sessions and then played back as videos for online learning. However, whether delivered in person or via video, these methods are mostly one-way in nature and use standardized teaching materials. Teachers are generally unable to accurately track each student's learning progress and condition. As the course continues, it becomes increasingly difficult for teachers to provide timely assistance to students who fall behind or perform poorly, and for students to fully master the subject matter—an issue that needs to be addressed.

In particular, these in-person or video-based teaching methods often rely heavily on printed textbooks. Both teachers and students must carry bulky physical materials, which can be inconvenient and even detrimental to physical development. Additionally, the materials are often dull and uniform, and there is a notable disparity in teaching quality and resources between urban and rural areas. As a result, students in different regions or classes may experience uneven learning outcomes, varying levels of motivation, and unequal access to resources. This can lead to unfair discrepancies in final learning results, such as test scores. Furthermore, this mode of instruction does not allow parents (or supervisors, or program administrators) to quickly access students' learning performance, nor does it enable timely intervention—such as adjusting course difficulty, replacing materials, or adding supplementary content. This shortcoming negatively impacts students' overall learning experience and requires improvement.

Additionally, with these traditional teaching methods, students usually only absorb content during class sessions and rarely engage in pre-class preparation or post-class review. As the course content becomes more complex, students may struggle to grasp concepts during class and fail to reinforce their understanding afterward. Over time, this results in stagnated learning progress, an accumulation of knowledge gaps, and a decline in motivation, potentially leading to disengagement from learning altogether and poor performance in future evaluations.

### SUMMARY OF THE INVENTION

A major objective of the present invention is, therefore, to overcome the above shortcomings and to provide a system and its operational method to enhance students' learning effectiveness and reduce the educational gap between urban and rural areas.

To achieve the objective, a generative AI educational system includes a backend server, a user-end device, and an administrator-end device.

The backend server stores an AI teacher instructional large model, a teaching material database, a 3D database, an AI test question large model, a student learning record database, a learning trajectory analytics module, and a student lesson preparation database. The AI teacher instructional large model is an AI model trained through machine learning using teaching scripts, 3D animation data, exam question banks, and historical question databases provided by teachers of various subjects. The teaching material database, 3D database, and AI test question large model are respectively used to store teaching materials, 3D animation data, and test question bank data of different subjects. The student learning record database is used to store learning feedback and responses provided by students during their study period. The learning trajectory analytics module is used to analyze student learning data. The student lesson preparation database is used to support students in preparing for lessons and recording related data.

The user-end device is an electronic display device, which is a tablet, computer, mobile phone, or augmented reality (AR) (or virtual reality (VR), mixed reality (MR)) device, used to link with the backend server and display the AI teacher instructional large model, teaching material database, 3D database, and AI test question large model from the backend server to support student learning. The user-end device is capable of inputting students' voice data to the backend server.

The administrator-end device is an electronic display device, which is a tablet, computer, or mobile phone, used to link with the backend server and display the student learning record database and the learning trajectory analytics module for an administrator to review. The administrator-end device is capable of inputting the administrator's voice and text data into the backend server.

An operational method for the generative AI educational system includes a teaching mode and a lesson preparation mode. In the teaching mode, the operational method includes the following steps:

A student uses the user-end device to study and view content; based on a current lesson, the backend server utilizes the AI teacher instructional large model in conjunction with the teaching material database, the 3D database, and the student learning record database to generate an AI teacher (S00) and begin instruction. The AI teacher instructional large model starts teaching using synchronized voice and text instruction (S01) based on the teaching material, or directly plays a 3D animation (S02). After synchronized voice and text instruction (S01) is completed, the AI teacher instructional large model chooses to either actively ask the student questions (S03), play a 3D animation (S02), or trigger an interactive 3D learning object (S04), which automatically change the 3D animation (S05). If the AI teacher instructional large model proceeds to actively ask the student a question (S03), and the student does not respond (S06), the AI teacher evaluates teaching context and progress (S07), then summarizes learning outcomes and records them in the student learning record database on the backend server (S08). If the student answers the question (S09), the AI teacher automatically change the 3D animation (S10) or ask whether the student would like to engage in deeper or broader learning (S11). If the student does not wish to continue with deeper learning, the AI teacher again evaluates context and teaching progress (S07), then summarizes learning outcomes and records them (S08). If the student does wish to engage in deeper learning, the AI teacher provides additional instructional materials (S12) to enhance the student's understanding, and then summarizes and records the learning outcomes in the student learning record database (S08). After providing the additional instructional materials (S12), the AI teacher search the 3D database for relevant content and play a corresponding video (S13), after which it summarizes and records learning outcomes (S08). The AI teacher presents the additional instructional materials in text format (S14), then proceed to change the 3D animation (S15) and record overall learning outcomes in the backend server's student learning record database (S08), thus completing the instructional session.

In the lesson preparation mode, the operational method includes the following steps:

A day before a scheduled course, a student logs into the backend server and, guided by the AI teacher, engages in preliminary learning to build lesson preparation materials (S20). After being taught by the AI teacher, the student records learning outcomes as teaching materials (S21) and stores them in the teaching material database of the backend server for future use (S22). The student lesson preparation database of the backend server generates an AI virtual student (S23) and an AI virtual teaching assistant (S24). The student orally teaches prepared materials (S25) to the AI virtual student and a role-playing student, with the AI virtual teaching assistant providing support during the instruction. The AI virtual student actively asks questions related to content (S26), which is answered by the role-playing student while the AI virtual student also learns (S27) and the student continues to teach by speaking (S25) until lesson concludes. When the role-playing student decides learning session is complete (S28), the backend server provides a test for the AI virtual student (S29). The AI virtual student's test results are then uploaded to the backend server, and performance rankings are published (S30), completing the student's lesson preparation process.

According to the above description, the present invention provides a system and its operational method to enhance students' learning effectiveness and reduce the educational gap between urban and rural areas.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing a generative artificial intelligence (AI) educational system according to an embodiment of the present invention.

FIG. 2 is a flow diagram showing a training process of the generative AI educational system of FIG. 1.

FIG. 3 is a flow diagram showing a teaching mode of the generative AI educational system of FIG. 1.

FIG. 4 is a flow diagram showing a lesson preparation mode of the generative AI educational system of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

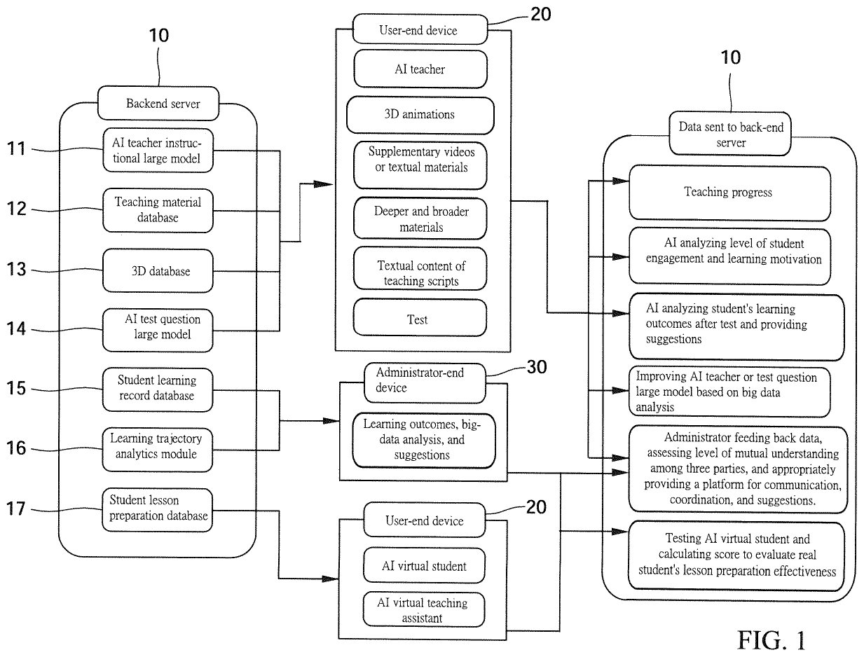

As shown in FIG. 1, a generative artificial intelligence (AI) educational system according to an embodiment of the present invention includes a backend server 10, a user-end device 20, and an administrator-end device 30.

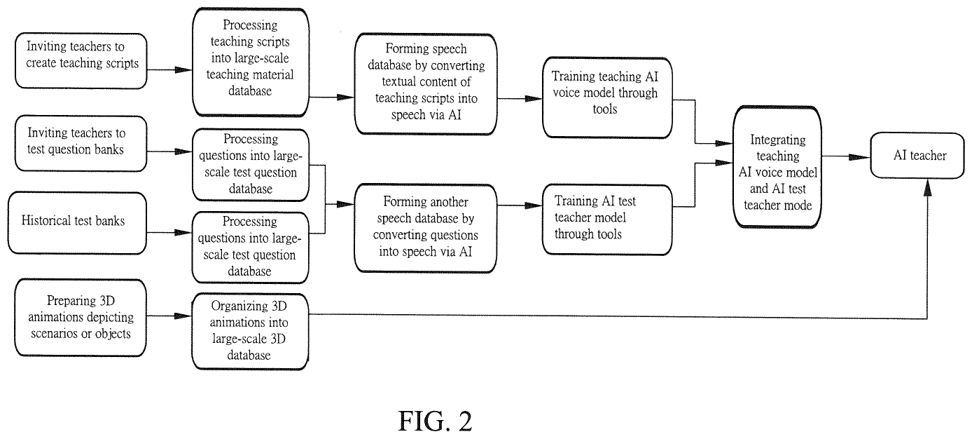

As also shown in FIG. 2, the backend server 10 stores an AI teacher instructional large model 11, a teaching material database 12, a 3D database 13, an AI test question large model 14, a student learning record database 15, a learning trajectory analytics module 16, and a student lesson preparation database 17. Among them, the AI teacher instructional large model 11 is an AI model trained through machine learning using teaching scripts, 3D animation data, exam question banks, and historical question databases provided by teachers of various subjects. The teaching material database 12, 3D database 13, and AI test question large model 14 are respectively used to store teaching materials, 3D animation data, and test question bank data of different subjects. The student learning record database 15 is used to store the learning feedback and responses provided by students during their study period. The learning trajectory analytics module 16 is used to analyze the student learning data. The student lesson preparation database 17 is used to support students in preparing for lessons and recording related data.

As shown in FIG. 1, the user-end device 20 is an electronic display device, which may be a tablet, computer, mobile phone, or augmented reality (AR) (or virtual reality (VR), mixed reality (MR)) device. It is used to link with the backend server 10 and display the AI teacher instructional large model 11, teaching material database 12, 3D database 13, and AI test question large model 14 from the backend server 10 to support student learning. It can also input students' voice data to the backend server 10.

As shown in FIG. 1, the administrator-end device 30 is an electronic display device, which may be a tablet, computer, or mobile phone. It is used to link with the backend server 10 and display the student learning record database 15 and the learning trajectory analytics module 16 for the administrator to review. It can also input the administrator's voice and text data into the backend server 10.

FIG. 2 depicts the process by which the AI teacher instructional large model 11 is trained. Teachers of multiple subjects are first invited to create teaching scripts, which are then processed into a large-scale teaching data repository. AI is used to convert the textual content of these scripts into speech, forming a speech database. This data is then used to train a teaching AI voice model through machine learning and deep learning techniques (e.g., using platforms such as OpenAI or Meta). At the same time, teachers of multiple subjects prepare exam question banks and historical question banks. These questions are processed into a large-scale question data repository, and AI is used to convert them into speech, forming another speech database. This data is then used to train an AI question bank teacher model using similar machine learning and deep learning methods. Additionally, various 3D animations representing scenarios or objects are prepared and organized into a 3D animation database. Finally, the teaching AI voice model and the AI question bank teacher model are integrated and combined with the 3D animation database to form a comprehensive AI teacher.

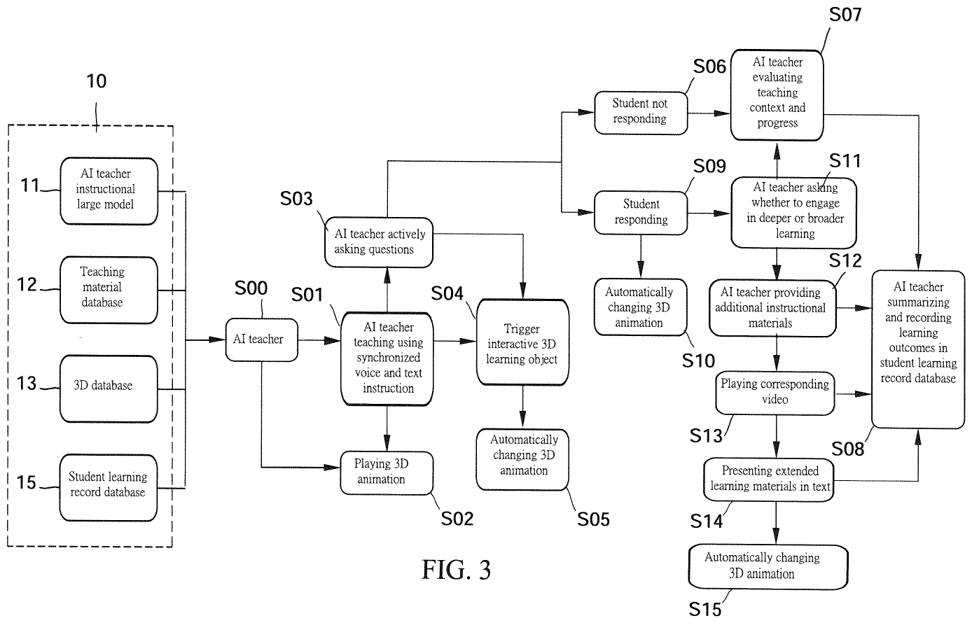

Based on the above-described system, an operational method of the system of the present embodiment includes a teaching mode and a lesson preparation mode. As shown in FIGS. 1 and 3, the teaching mode includes the following steps:

A student uses the user-end device 20 to study and view content. Based on a current lesson, the backend server 10 utilizes the AI teacher instructional large model 11 in conjunction with the teaching material database 12, the 3D database 13, and the student learning record database 15 to generate an AI teacher (S00) and begin instruction. The AI teacher instructional large model 11 starts teaching using synchronized voice and text instruction (S01) based on the teaching material, or directly plays a 3D animation (S02). After the voice and text instruction (S01) is completed, the AI teacher instructional large model 11 may choose to either actively ask the student questions (S03), play a 3D animation (S02), or trigger an interactive 3D learning object (S04), which may automatically change the 3D animation (S05). If the AI teacher instructional large model 11 proceeds to actively ask the student a question (S03), and the student does not respond (S06), the AI teacher evaluates the teaching context and progress (S07), then summarizes the learning outcomes and records them in the student learning record database 15 on the backend server 10 (S08). If the student answers the question (S09), the AI teacher may automatically change the 3D animation (S10) or ask whether the student would like to engage in deeper or broader learning (S11). If the student does not wish to continue with deeper learning, the AI teacher again evaluates the context and teaching progress (S07), then summarizes the learning outcomes and records them (S08). If the student does wish to engage in deeper learning, the AI teacher provides additional instructional materials (S12) to enhance the student's understanding, and then summarizes and records the learning outcomes in the student learning record database (S08). Additionally, after providing extended learning materials (S12), the AI teacher may search the 3D database 13 for relevant content and play a corresponding video (S13), after which it will summarize and record the learning outcomes (S08). The AI teacher may also present the extended learning materials in text format (S14), then proceed to change the 3D animation (S15) and record the overall learning outcomes in the backend server's student learning record database (S08), thus completing the instructional session.

Parents, teachers, or supervisors can use the administrator-end device 30 to link with the student learning record database 15 and the learning trajectory analytics module 16 of the backend server 10, allowing them to monitor the student's learning progress in real time.

Through the above method, the AI teacher utilizes the teaching materials and 3D animations stored in the backend server 10 to conduct lessons for students. Students, using the user-end device 20, can interact with and follow the AI teacher's instructional content in real time. As the lesson progresses, the AI teacher records the student's learning activities in real time and stores them in the backend server 10. Parents, teachers, supervisors, and other administrators can access the backend server 10 using the administrator-end device 30 to access the student learning record database 15 and the learning trajectory analytics module 16, allowing them to monitor the student's learning progress in real time.

Additionally, the AI teacher stores the teaching progress based on the learning records and can use AI to analyze the level of student engagement and learning motivation. The AI test question large model 14 provides test questions for students to assess their learning, and evaluates each student's performance based on the test results. These data are further used to improve the AI teacher and the AI test question large model 14 through big data analytics. After reviewing the student's learning records, parents, teachers, or supervisors can provide feedback. The learning trajectory analytics module 16 then evaluates the mutual understanding among the three parties—student, teacher, and administrator—based on the student's learning records and the feedback data, and appropriately provides a platform for communication, coordination, and suggestions.

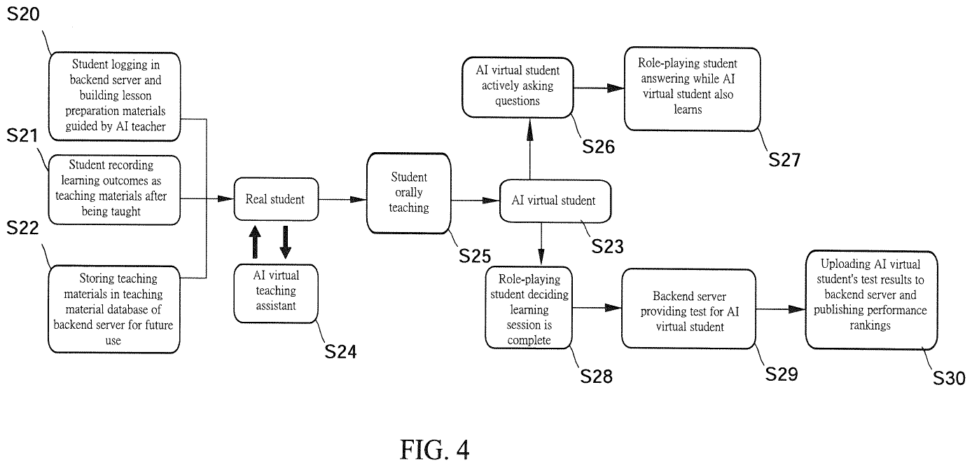

As shown in FIG. 1, the backend server 10 of the present invention is equipped with a student lesson preparation database 17. As further illustrated in FIG. 4, this represents the lesson preparation mode of the present embodiment, which includes the following steps:

The day before a scheduled course, a student logs into the backend server 10 and, guided by the AI teacher, engages in preliminary learning to build lesson preparation materials (S20). After being taught by the AI teacher, the student records the learning outcomes as teaching materials (S21) and stores them in the teaching material database 12 of the backend server 10 for future use (S22). Then, the student lesson preparation database 17 of the backend server 10 generates an AI virtual student (S23) and an AI virtual teaching assistant (S24). The student orally teaches the prepared materials (S25) to the AI virtual student and role-playing student, with the AI virtual teaching assistant providing support during the instruction. The AI virtual student actively asks questions related to the content (S26), which may be answered by the role-playing student. The AI virtual student also learns during the process (S27), while the student continues to teach by speaking (S25) until the lesson concludes. When the role-playing student decides the learning session is complete (S28), the backend server 10 provides a test for the AI virtual student (S29). The AI virtual student's test results are then uploaded to the backend server 10, and the performance rankings are published (S30), completing the student's lesson preparation process.

Through the above method, since students are required to teach the AI virtual student to understand the lesson content and provide learning data to the student lesson preparation database 17, they must actively preview and prepare the course material. At the same time, because the AI virtual student takes a test based on the content taught by the student and is ranked accordingly, this serves as an evaluation of the student's lesson preparation performance. As a result, students are motivated to thoroughly prepare and effectively teach the AI virtual student, thereby enhancing their willingness to engage in active learning. Furthermore, when the AI teacher conducts the formal lesson, students are more likely to comprehend and absorb the content, ultimately improving overall learning outcomes.

Accordingly, from the above description, the present invention offers the following advantages:
1. The teaching materials for each course are stored in the backend server 10, and an AI teacher instructional large model 11 is established for each subject, enabling the generation of different AI teachers specialized in various disciplines. Students can access the backend server 10 using a user-end device 20 to receive instruction from the AI teacher, supplemented by 3D animation videos. This makes the teaching content engaging and interactive, and eliminates the need for printed textbooks, thereby reducing the weight of students' backpacks or bags.
2. As the course progresses, the AI teacher can record students' learning activities and track their progress in real time. This data can be used for later review and course adjustment analysis. In subsequent lessons, the AI teacher can tailor the difficulty level of the content based on each student's individual learning records, achieving personalized instruction and addressing disparities in teaching quality, such as those between urban and rural areas.
3. Administrators can use the administrator-end device 30 to access the backend server 10 to monitor students' learning records and statuses at any time. This enables timely intervention or guidance, thereby improving students' learning confidence and outcomes.
4. The present invention allows students to teach AI virtual students as part of a lesson preparation process, encouraging pre-class study and improving learning effectiveness. Through test-based assessments provided by the question bank, the system can effectively evaluate student learning performance and adjust course content or difficulty accordingly, thereby enhancing overall learning outcomes.
5. The system enables students to link with the backend server 10 via a user-end device 20, where AI teachers deliver the lessons. Real-life teachers take on supporting and observational roles, assisting students with device usage and monitoring their engagement during lessons. During class, real teachers can access the backend server 10 via an administrator-end device 30 to observe each student's learning status and progress. The AI teacher provides real-time feedback or alerts to notify the real teacher of student needs, allowing for timely individual support. This teaching system can fully replace traditional in-person instruction, with real teachers primarily ensuring that students are placed in learning environments suited to their proficiency levels. As such, real teachers act only as facilitators and observers, which also reduces the instructional burden and time pressure on educators. Therefore, the present invention demonstrates significant advancement and practical utility.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A generative artificial intelligence (AI) educational system comprising a
backend server, a user-end device, and administrator-end device, wherein the backend server stores an AI teacher instructional large model, a teaching material database, a 3D database, an AI test question large model, a student learning record database, a learning trajectory analytics module, and a student lesson preparation database;
the AI teacher instructional large model is an AI model trained through machine learning using teaching scripts, 3D animation data, exam question banks, and historical question databases provided by teachers of various subjects;
the teaching material database, 3D database, and AI test question large model are respectively used to store teaching materials, 3D animation data, and test question bank data of different subjects;
the student learning record database is used to store learning feedback and responses provided by students during their study period;
the learning trajectory analytics module is used to analyze student learning data;
the student lesson preparation database is used to support students in preparing for lessons and recording related data;
the user-end device is an electronic display device, which is a tablet, computer, mobile phone, or augmented reality (AR) (or virtual reality (VR), mixed reality (MR)) device, used to link with the backend server and display the AI teacher instructional large model, teaching material database, 3D database, and AI test question large model from the backend server to support student learning; the user-end device is capable of inputting students' voice data to the backend server;
the administrator-end device is an electronic display device, which is a tablet, computer, or mobile phone, used to link with the backend server and display the student learning record database and the learning trajectory analytics module for an administrator to review; and the administrator-end device is capable of inputting the administrator's voice and text data into the backend server.

2. An operational method for a generative AI educational system, applied to the generative AI educational system claimed in claim 1, comprising a teaching mode and a lesson preparation mode, wherein, in the teaching mode, the operational method comprises the following steps:
a student uses the user-end device to study and view content; based on a current lesson, the backend server utilizes the AI teacher instructional large model in conjunction with the teaching material database, the 3D database, and the student learning record database to generate an AI teacher (S00) and begin instruction;
the AI teacher instructional large model starts teaching using synchronized voice and text instruction (S01) based on the teaching material, or directly plays a 3D animation (S02);
after synchronized voice and text instruction (S01) is completed, the AI teacher instructional large model chooses to either actively ask the student questions (S03), play a 3D animation (S02), or trigger an interactive 3D learning object (S04), which automatically change the 3D animation (S05);
if the AI teacher instructional large model proceeds to actively ask the student a question (S03), and the student does not respond (S06), the AI teacher evaluates teaching context and progress (S07), then summarizes learning outcomes and records them in the student learning record database on the backend server (S08);
if the student answers the question (S09), the AI teacher automatically change the 3D animation (S10) or ask whether the student would like to engage in deeper or broader learning (S11);
if the student does not wish to continue with deeper learning, the AI teacher again evaluates context and teaching progress (S07), then summarizes learning outcomes and records them (S08);
if the student does wish to engage in deeper learning, the AI teacher provides additional instructional materials (S12) to enhance the student's understanding, and then summarizes and records the learning outcomes in the student learning record database (S08);
after providing the additional instructional materials (S12), the AI teacher search the 3D database for relevant content and play a corresponding video (S13), after which it summarizes and records learning outcomes (S08);
the AI teacher presents the additional instructional materials in text format (S14), then proceed to change the 3D animation (S15) and record overall learning outcomes in the backend server's student learning record database (S08), thus completing the instructional session;
wherein, in the lesson preparation mode, the operational method comprises the following steps:
a day before a scheduled course, a student logs into the backend server and, guided by the AI teacher, engages in preliminary learning to build lesson preparation materials (S20);
after being taught by the AI teacher, the student records learning outcomes as teaching materials (S21) and stores them in the teaching material database of the backend server for future use (S22);
the student lesson preparation database of the backend server generates an AI virtual student (S23) and an AI virtual teaching assistant (S24);
the student orally teaches prepared materials (S25) to the AI virtual student and a role-playing student, with the AI virtual teaching assistant providing support during the instruction;
the AI virtual student actively asks questions related to content (S26), which is answered by the role-playing student while the AI virtual student also learns (S27) and the student continues to teach by speaking (S25) until lesson concludes;
when the role-playing student decides learning session is complete (S28), the backend server provides a test for the AI virtual student (S29);
the AI virtual student's test results are then uploaded to the backend server, and performance rankings are published (S30), completing the student's lesson preparation process.

3. A training method for an AI teacher instructional large model, applied to the generative AI educational system claimed in claim 1, comprising the following steps:
inviting teachers of multiple subjects to create teaching scripts, which are then processed into a large-scale teaching material database;
using AI to convert textual content of the teaching scripts into speech, forming a speech database, which is used to train a teaching AI voice model through machine learning and deep learning techniques;
inviting teachers of multiple subjects to create test question banks and historical test banks, where questions are processed into a large-scale question database;
using AI to convert the questions into speech to form a speech database, which is used to train an AI test teacher model
preparing and organizing a plurality of 3D animations depicting various scenarios or objects into a 3D database; and
integrating the teaching AI voice model and the AI test teacher model and combining them with the 3D database to form an AI teacher.
